(19) United States
(12) Patent Application Publication
(10) Pub. No.: US 2018/0063507 A1
(43) Pub. Date: Mar. 1, 2018

(54) Apparatus for recording stereoscopic panoramic photography

(71) Applicants: Philippe Cho Van Lieu, Daly City, CA (US); Dave Arendash, Fremont, CA (US)

(72) Inventors: Philippe Cho Van Lieu, Daly City, CA (US); Dave Arendash, Fremont, CA (US)

(21) Appl. No.: 15/096,227

(22) Filed: Apr. 11, 2016

Related U.S. Application Data
(60) Provisional application No. 62/179,375.

(51) Int. Cl. H04N 13/02; H04N 5/247; H04N 5/232

(52) U.S. Cl. CPC H04N 13/0242; H04N 5/23238; H04N 5/247

(57) ABSTRACT

A camera apparatus which places thirteen individual cameras in pairs between two triangle-shaped tiers as to record stereoscopic panoramic motion pictures.

### CROSS-REFERENCE TO RELATED APPLICATIONS

Provisional Patent Application No. 62/178,375

Filing Date: Apr. 9, 2015

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Photography, which covers both still and motion pictures, have been around for the better part of a century. Both stereoscopic photography and panoramic photography have likewise been around for just as long. However, stereoscopic AND panoramic photography is a relatively recent development, as combining the two has been a difficult task which required an evolution of technology before it became viable. In particular, video technology had to shrink in size while record larger dimension videos. At this moment, several patents similar to our apparatus exist, including:
U.S. Pat. No. 7,347,555 B2—Multi-dimensional imaging apparatus, systems, and methods; Grover
US 20040001138 A1—Stereoscopic panoramic video generation system; Weerashinghe, Ogunbona, Li
US 20130250040 A1—Capturing and Displaying Stereoscopic Panoramic Images; Vitsnudel, Sorek

However, the shortcomings of these similar patents is that their particular designs:
don't reduce potential parallax errors relative to the size of the apparatus;
requires more cameras (which increases expense and/or mechanical error);
are set for one particular size (the apparatus is not resizable);
prevent subjects from being able to get close the apparatus; and/or,
don't have a very “strong” stereoscopic effect.

All in all, these limitations prevent a user from capturing a stereoscopic panoramic still or motion picture in an efficient and effective manner.

### SUMMARY OF THE INVENTION

This apparatus is a method for filmmakers to record motion pictures as both stereoscopic and panoramic, in such a way that helps maintain a “strong” stereoscopic effect, while limiting potential parallax errors in order to enable a proper stitching of the recorded footage. With a parallax errors reduced, it in turn allows subjects to get close to the apparatus, which provides for a more intimate experience on the part of the user viewing the stereoscopic panoramic motion picture.

Specifically, the invention is uses several pairs of cameras (such as GoPro cameras), arranged in a triangle formation at 180 degrees from one another, with at least one camera positioned on the top of the apparatus, pointing up. The novelty of this invention is that some of the cameras are inverted and placed above the others. This allows for a closer arrangement of the cameras, which in turn allows for a greater range of scalability and a decrease in parallax errors relative to other stereoscopic panoramic camera rig systems.

### BRIEF DESCRIPTION OF THE DRAWINGS

FIG. 1 is a perspective view of the apparatus, using six pairs of cameras and one pointing up as an example of a potential design for the apparatus;

FIG. 2 is a top view of the apparatus of FIG. 1, showing camera positions and measuring certain distances;

FIG. 3 is a comparison of the apparatus of FIG. 1 relative to other stereoscopic panoramic motion picture recording devices, showing camera positions and measuring certain distances;

FIG. 4 is a diagram showing certain measurements of one half of the apparatus.

### DETAILED DESCRIPTION OF THE INVENTION

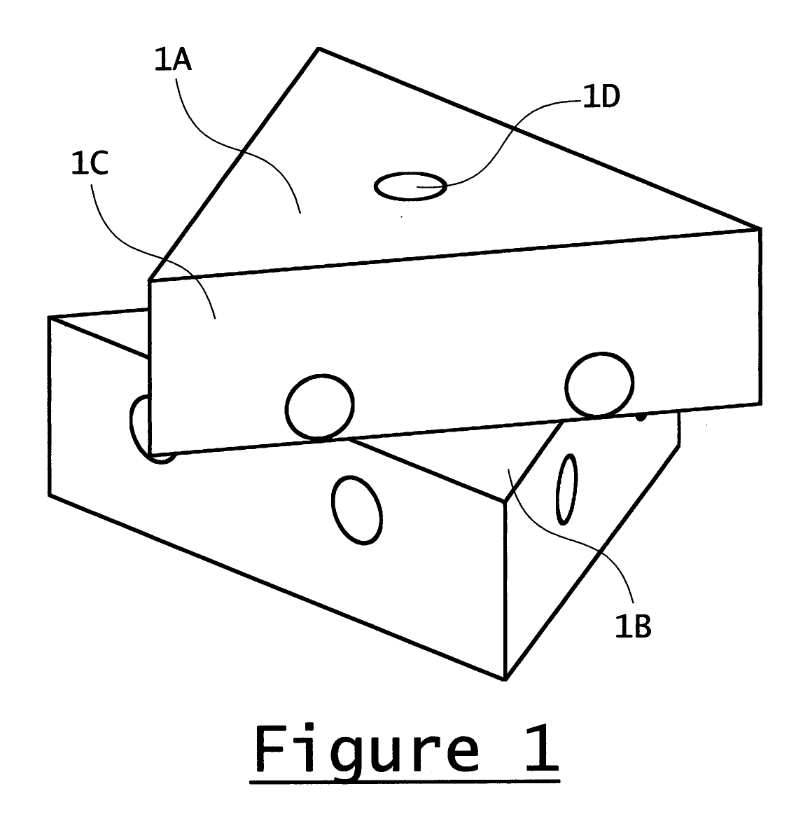

Referring now to the invention in more detail; in FIG. 1 there is an apparatus with two tiers 1A 1B. Both tiers have a pair of cameras 1C, with the lens set a certain distance apart from one another. All pairs of cameras on the top tier 1A have their cameras as close to the center axis as possible; in this case, towards the bottom of the top tier. Likewise, the pairs of cameras on the bottom tier 1B are as close to the center axis as possible; in this case, towards the top of the bottom tier. Furthermore, on the top tier, there is a single camera 1D, pointing up. For optimal recording, each camera needs to have a minimum field of view of 90 degrees, however an absolute minimum field of view of 60 degrees is still acceptable.

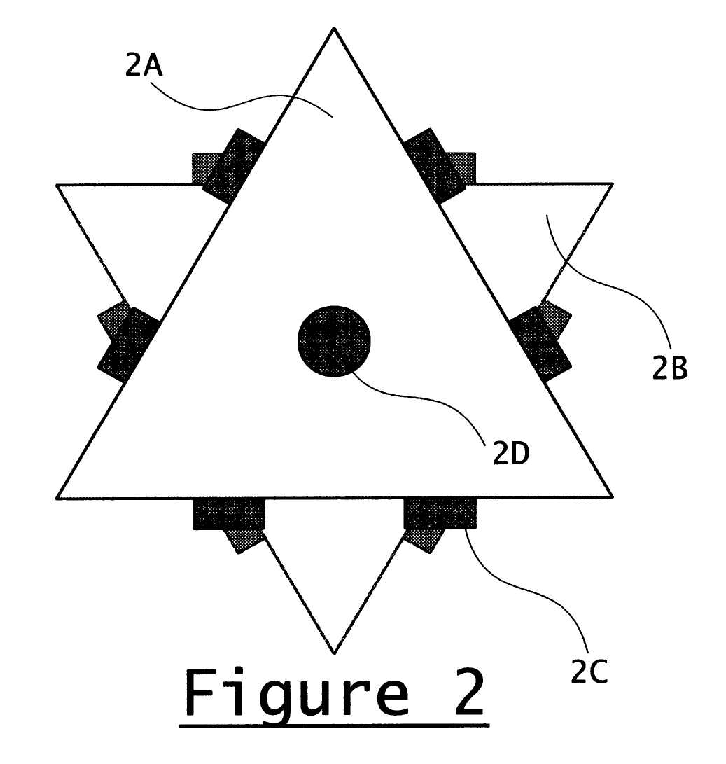

Referring now to FIG. 2; there is shown the apparatus from the top. The top tier 2A is rotated 180 degrees relative to the bottom tier 2B. Each camera 2C on the top tier are located directly above another camera on the bottom tier. The top-pointing camera 2D is placed directly in the center of the axis of the apparatus.

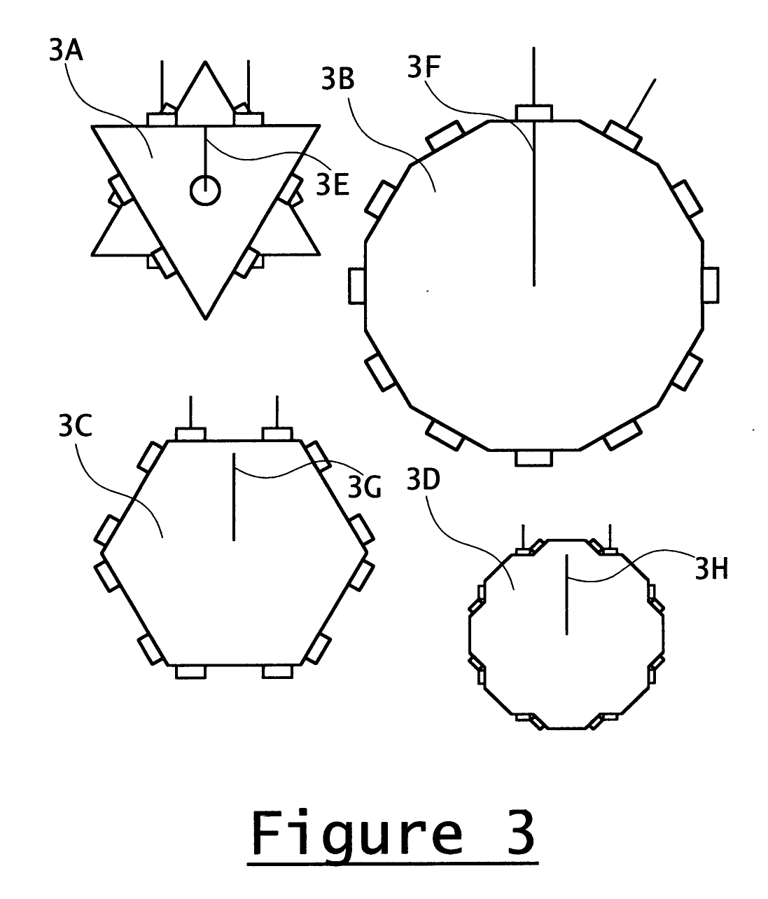

Referring now to FIG. 3; the apparatus 3A is compared with multiple other stereoscopic panoramic motion picture capture devices 3B 3C 3D, with each pair of lenses placed a certain but exactly same distance from one another. Device 3B uses twelve cameras placed in a circle. Device 3C places pairs of cameras in a hexagon. Device 3D uses eight pairs of camera with a Left Camera at a 22.5 degree angle from a Right Camera. All devices have pairs of cameras placed a certain distance away from their axis 3E 3F 3G 3G. The advantages of the apparatus is that the distance each pair of camera in the apparatus is away from the axis 3E is the shortest of all the distances of the other three devices 3F 3G 3H. This helps reduce parallax errors and makes stitching the motion pictures recorded by the apparatus easier.

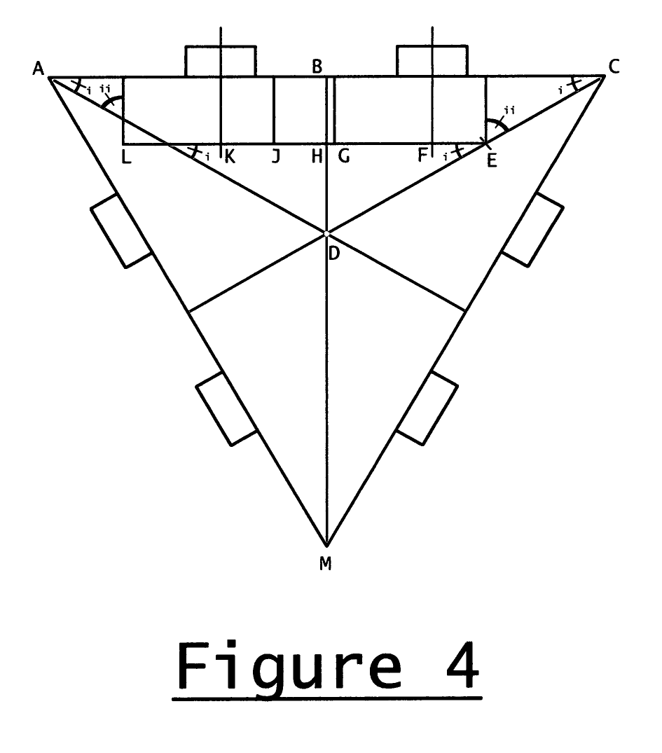

Referring now to FIG. 4; one section of the apparatus is shown in order to describe how it is designed. This one section represents all pairs of cameras in the apparatus. There exists two camera units of width JL & EG and depth BH (the line from Point E and Point L to line AC equal BH). Left camera JL has a lens of which the center is a certain distance JK and KL. Right camera EG has a lens of which the center is a certain distance EF and FG. The distance between FH and HK are equal; this length is customizable. The length of line GH is (FH−FG). The length of line JH is (HK−JK). All angles “i” are equal to 30 degrees. All angles “ii” are equal to 60 degrees. All angles D are 60 degrees. The length of line CE is (BH/(sin(30 deg))). The length of line DH is (EH*(tan(30 deg))). The length of line DE is (DH/(sin(30 deg))). The length of line BD is (BH+DH). The length of line BC is (CD*(cos(30 deg))). The length of line AC is (2*BC). The length of line BM is (((sqrt(3))/2)*AC). Triangle ACM is an equilateral triangle.

In further detail, the above equations describes the design of the bottom tier 1B. The design of the top tier 1A is the same, simply mirror-flipped.

The advantages of the present invention include, without limitation, that it allows a Virtual Reality (“VR”) filmmaker who is interested in stereoscopic panoramic filmmaking to film a scene that most accurately replicates the reality that is being recorded in the most efficient and effective way. The present invention provides the user with a format that makes subsequent stitching, editing, processing and rendering of the recorded stereoscopic panoramic footage as simple as possible, requiring a minimal level of effort to produce, while ultimately providing the filmmaker with an extremely accurate reproduction of the experience they captured. Ultimately, this technology is both new and non-obvious, as the double-tiered format has not been replicated by other stereoscopic, panoramic, and stereoscopic-panoramic photographic capturing devices, nor as any similar invention has been able to address the same issues that the present invention has been able to.

In broad embodiment, the present invention is a system and method that allows a user to most accurately and efficiently capture a moment in time in such a way that allows them to create a stereoscopic panoramic still or motion picture in the most effective manner.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A system comprising of multiple pairs of cameras, arranged in a specific pattern between two tiers, arranged in a triangle-shape, with the top tier rotated 180-degrees relative to the bottom pair, with each pair facing outwards from the center of the camera, and several cameras placed on the top of the two triangle arrangements of cameras, pointing upwards.

2. A system recited in claim 1 wherein said camera(s) can be:
of any form that is able to record footage onto medium
of any form that has a lens with a field of view of at least 60-degrees, horizontal and vertical
of any form that is powered from an independent or shared source
of a form that is either an all-in-one enclosed camera (such as a GoPro or similar camera) or a CCD with lens (with any number of said CCDs connected to any number of power, memory, CPU).
of any form that is able to capture any other form of visual data, including (but not limited to) distance information, biofeedback data, position of subject or object, infrared or ultraviolet light, data to be used in photogrametry and/or stereophotogrammetry

3. A system recited in claim 1 wherein said arrangement can be:
of any form that is able to house the cameras in the aforementioned pattern, such as 3D-printed ABS plastic, welded aluminum, or injection molded plastic
of any form that is able to keep the cameras in the aforementioned pattern, regardless of the ultimate size of the arrangement
of any form of a two tired triangle format, regardless of the actual shape of the triangle format (whether equilateral triangle or not)
of any form where there is a two-tiered triangle format with each side housing a pair of cameras, regardless of the actual shape of the camera pairs relative to one another (as depicted in FIG. 4)

4. A system recited in claim 1 wherein said pairs of cameras “facing out” can be:
of any form where the cameras lenses are ultimately recording visual footage in any direction away from the center axis
of any form that allows the cameras to record footage in the aforementioned direction, regardless of how the cameras themselves are positions within the system (using—but not limited to—mirrors, prisms, extra lenses, to transfer the image being recorded to the cameras themselves)

5. A system recited in claim 1 wherein the multiple pairs of cameras can be:
of any form where the cameras can be placed anywhere in the system itself, but still attached to the system
of any form where the cameras can be of any type of camera recited in claim 2

6. A system recited in claim 1 wherein the invention can include any number of extra features to aid the operation and maintenance of the camera, such as a fan to maintain the proper operating temperature of the invention, a screw-mount to attach the system to a tripod.

7. A system recited in claim 1 wherein the recorded footage created in claim 2 can be of any format, be it digital (such as H.264, H.265, or similar video codecs) or physical (such as 8-, 16-, 32-mm film, or similar film medium)

8. A system recited in claim 1 wherein the cameras described in claim 2:
of any form where any of the cameras may or may not all be in operation at the same time; any number of the cameras may be in active and/or recording while the system itself is in operation
of any form where not all of the cameras may or may not be on and functioning at the same time, or even connected to the system itself, at any given moment

9. A system recited in claim 1 wherein the triangle format created in claim 3 may have any part of the triangle-shape modified, adjusted, increased or reduced in size, to aid the proper operation and recording of footage.
